(19) United States
(12) Patent Application Publication
(10) Pub. No.: US 2015/0214593 A1
(43) Pub. Date: Jul. 30, 2015

(54) HIGH-FREQUENCY PHASE SHIFTER CAPABLE OF SHIELDING RADIATION

(71) Applicant: GAMMA NU, INC., Hwaseong-si (KR)

(72) Inventors: Sang Gi KIM, Hwaseong-si (KR); Jong Sung KIM, Hwaseong-si (KR); Sang Jin KIM, Hwaseong-si (KR)

(21) Appl. No.: 14/583,282

(22) Filed: Dec. 26, 2014

(30) Foreign Application Priority Data
Jan. 24, 2014 (KR) 10-2014-0008969

(51) Int. Cl. H01P 1/18; H01Q 3/34

(52) U.S. Cl. CPC H01P 1/184; H01Q 3/34

(57) ABSTRACT

A high-frequency phase shifter capable of shielding radiation includes a conductive cover formed in a microstrip line form and configured to shield the radiation of microstrip lines, wherein the phase shifter operates in a frequency band of 2 GHz or more. An antenna may include a phase shifter configured in a microstrip line form and radiation elements supplied with phase-shifted signals from the phase shifter and configured to radiate electromagnetic waves in a frequency band of 2 GHz or more, wherein a conductive cover configured to shield the radiation of the phase shifter is formed in the antenna.

### CROSS REFERENCE TO RELATED APPLICATION

The present application claims the benefit Korean Patent Application No. 10-2014-0008969 filed in the Korean Intellectual Property Office on Jan. 24, 2014, the entire contents of which are incorporated herein by reference.

### BACKGROUND OF THE INVENTION

1. Technical Field

The present invention relates to a high-frequency phase shifter capable of shielding radiation and, more particularly, to a phase shifter, which is formed in a microstrip line form and is capable of solving a problem in that a passive intermodulation (PIM) characteristic becomes unstable when the phase shifter operates in a high frequency band of 2 GHz or more.

2. Description of the Related Art

A phase shifter is a device for shifting the phase of an input signal and generating an output signal having the shifted phase. Such a phase shifter may be used in various fields that use the phase difference of a signal, but is widely used in the antenna field. More specifically, the phase shifter is widely used to generate a phase shift signal required to implement an electrical beam tile of an antenna (e.g., a phase shift signal to be supplied to the radiation elements of an antenna).

Such a phase shifter may be configured in various forms. Recently, a phase shifter of a microstrip line form is widely used. The reason for this is that the phase shifter of a microstrip line form can be easily fabricated and mass-produced because the phase shifter is etched in a dielectric substrate and designed to have a required characteristic.

The phase shifter of a microstrip line form has a negligible radiation loss in a low frequency band, but has a loss because it has the amount of radiation increasing according to an increase of the frequency in a high frequency band, in particular, in a band of 2 GHz or more. Accordingly, the phase shifter of a microstrip line is problematic in that a radiated radio wave generates external interference, deteriorates a front to back (R/B) ratio characteristic, and makes unstable a passive intermodulation (PIM) characteristic.

Accordingly, it is difficult for the phase shifter of a microstrip line form to be used in the band of 2 GHz or more. Although the phase shifter of a microstrip line form is used in the band of 2 GHz or more, operation efficiency is significantly reduced due to the deterioration of the F/B characteristic and the PIM characteristic.

Accordingly, there is a need to develop a new phase shifter capable of solving such problems.

### SUMMARY OF THE INVENTION

Accordingly, the present invention has been made keeping in mind the above problems occurring in the prior art, and an object of the present invention is to fabricate a phase shifter of a microstrip line form, which does not deteriorate the performance of an antenna even in a high frequency band of 2 GHz or more.

Technical objects to be achieved by the present invention are not limited to the aforementioned object, and those skilled in the art to which the present invention pertains may evidently understand other technical objects from the following description.

A phase shifter in accordance with an embodiment of the present invention includes a conductive cover formed in a microstrip line form and configured to shield the radiation of microstrip lines, wherein the phase shifter operates in a frequency band of 2 GHz or more.

Furthermore, in the phase shifter in accordance with an embodiment of the present invention, the phase shifter implements an electrical beam tilt of a mobile communication radio wave in the frequency band of 2 GHz or more. The phase shifter is formed in a mobile communication sector antenna.

Furthermore, in the phase shifter in accordance with an embodiment of the present invention, the conductive cover includes a metal cover or a die casting cover.

Furthermore, in the phase shifter in accordance with an embodiment of the present invention, the phase shifter further includes a fixed substrate formed in a microstrip line form and a mobile substrate configured to dynamically form a phase shift line along with the fixed substrate and formed in a microstrip line for. The conductive cover shields the radiation of the fixed substrate or the mobile substrate.

Furthermore, in the phase shifter in accordance with an embodiment of the present invention, a first surface of the fixed substrate and a first surface of the mobile substrate are disposed to come in contact with each other with an insulating layer interposed between the fixed substrate and the mobile substrate.

Furthermore, in the phase shifter in accordance with an embodiment of the present invention, the conductive cover includes a vertical cover surface configured to shield radiation waves radiated in a direction normal to the fixed substrate and the mobile substrate and horizontal cover surfaces configured to shield radiation waves radiated in a direction parallel to the fixed substrate and the mobile substrate.

Furthermore, in the phase shifter in accordance with an embodiment of the present invention, the conductive cover includes a first cover configured to shield radiation waves laterally radiated on a second surface of the mobile substrate and a second cover configured to shield radiation waves laterally radiated on a second surface of the fixed substrate.

An antenna in accordance with an embodiment of the present invention includes a phase shifter configured in a microstrip line form and radiation elements supplied with phase-shifted signals from the phase shifter and configured to radiate electromagnetic waves in a frequency band of 2 GHz or more. A conductive cover configured to shield the radiation of the phase shifter is formed in the antenna.

### BRIEF DESCRIPTION OF THE DRAWINGS

FIGS. 1 and 2 are exemplary diagrams illustrating an example of a phase shifter configured in a microstrip line form;

FIG. 3 is an exemplary diagram illustrating that the phase shifter has been installed in a sector antenna;

FIG. 4 is an exploded perspective view of the phase shifter in accordance with an embodiment of the present invention; and

FIGS. 5 and 6 are perspective views illustrating a phase shifter in accordance with another embodiment of the present invention.

### DESCRIPTION OF REFERENCE NUMERALS OF PRINCIPAL ELEMENTS IN THE DRAWINGS

| | |
|---|---|
| 100: phase shifter | 110: fixed substrate |
| 111: first line pattern | 112: input pattern |
| 113: output pattern | 120: mobile substrate |
| 121: second line pattern | 200: conductive cover |
| 211: vertical cover surface | |
| 212: horizontal cover surface | |
| 220: first cover | 221: (1-1)^{th} cover |
| 222: (1-2)^{th} cover | 230: second cover |
| 232: (2-2)^{th} cover | |

### DETAILED DESCRIPTION

Hereinafter, phase shifters according to embodiments of the present invention are described in detail with reference to the accompanying drawings. The embodiments to be described are provided in order for those skilled in the art to easily understand the technical spirit of the present invention, and the present invention is not restricted by the embodiments. Furthermore, matters represented in the accompanying drawings have been diagrammed in order to easily describe the embodiments of the present invention, and the matters may be different from forms that are actually implemented.

Elements to be described herein are only examples for implementing the embodiments of the present invention. Accordingly, in other implementations of the present invention, different elements may be used without departing from the spirit and scope of the present invention. Furthermore, each of the elements may be purely formed of a hardware or software element, but may also be implemented using a combination of various hardware and software elements that perform the same function.

Furthermore, an expression that some elements are “included” is an expression of an “open type”, and the expression simply denotes that the corresponding elements are present, but it should not be understood that additional elements are excluded.

Furthermore, terms including ordinal numbers, such as the first and the second, may be used to describe various elements, but the terms are used to only “distinguish” one element from the other element. The attributes of the elements are not limited by the terms.

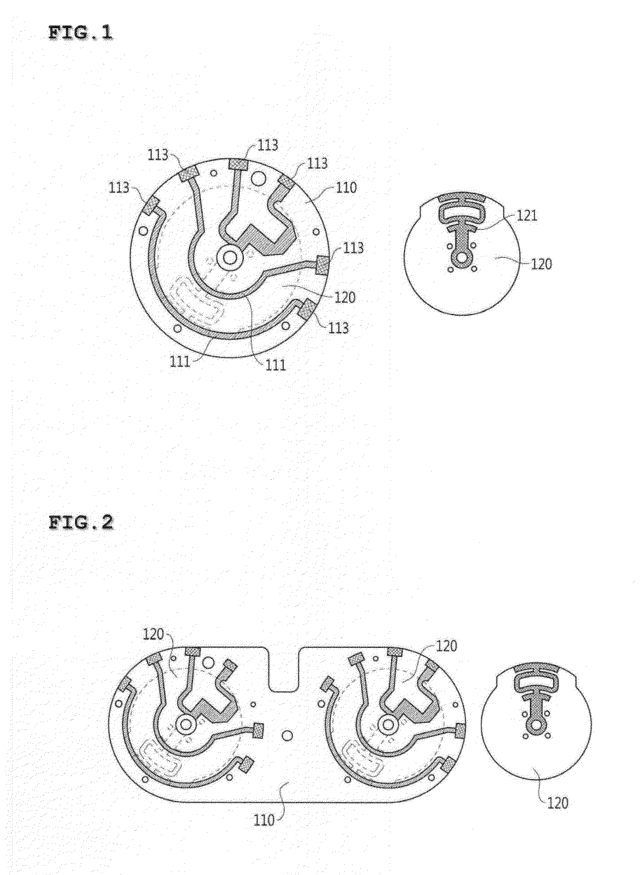

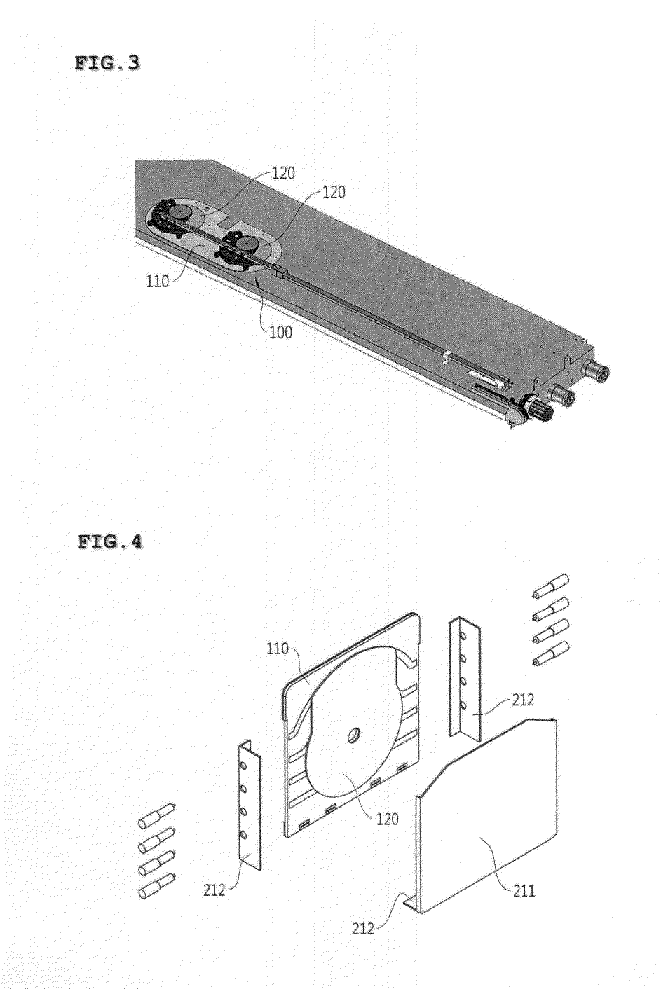

A phase shifter in accordance with an embodiment of the present invention is described below with reference to FIGS. 1 to 4.

For reference, the phase shifter to be described below in accordance with an embodiment of the present invention may be installed in various devices in which the phase of a signal needs to be changed, but may be installed in the sector antenna of a mobile communication system, for example. The reason for this is that the utilization of a high frequency band (e.g., 2 GHz or more) is increased in such a sector antenna field.

Referring to FIGS. 1 to 4, the phase shifter in accordance with an embodiment of the present invention may include a fixed substrate 110 configured in a microstrip line form, a mobile substrate 120 configured to dynamically form a phase shift line along with the fixed substrate and formed in a microstrip line form, and a conductive cover 200 configured to shield the radiation of the microstrip line formed in the fixed substrate 110 or the mobile substrate 120.

The fixed substrate 110 is formed in a microstrip form and formed in a fixed form. The fixed substrate 110, together with the mobile substrate 120, dynamically forms a phase shift line for shifting the phase of a signal. To this end, first line patterns 111, input patterns 112, and a plurality of output patterns 113 may be formed in one surface of the fixed substrate 110.

The mobile substrate 120 is configured to move (e.g., a rotary motion or a rectilineal motion) differently from the fixed substrate 110. Like the fixed substrate 110, the mobile substrate 120 is formed in a microstrip line form. As described above, the mobile substrate 120, together with the fixed substrate 110, dynamically forms the phase shift line for shifting the phase of a signal. To this end, a second line pattern 121 may be formed in one surface of the mobile substrate 120.

The fixed substrate 110 and the mobile substrate 120 may be disposed in such a way as to come in contact with each other with an insulating layer interposed therebetween. More specifically, one surface of the fixed substrate 110 in which the first line patterns 111 are formed and one surface of the mobile substrate 120 in which the second line pattern 121 is formed may be disposed in such a way as to come in contact with each other with the insulating layer interposed therebetween. In such a case, the first line patterns and the second line pattern may be subject to capacitive coupling, and the phase shift line for shifting the phase of a signal can be formed through such coupling.

Furthermore, the fixed substrate 110 and the mobile substrate 120 may dynamically form the phase shift line through a movement of the mobile substrate 120. More specifically, the fixed substrate 110 and the mobile substrate 120 may change a physical distance from the input patterns to the respective output patterns through such a movement of the mobile substrate 120. Accordingly, the degree that the phase of each output signal is shifted can be changed.

Furthermore, the fixed substrate 110 and the mobile substrate 120 may be formed in a circular type as illustrated in FIGS. 1 and 2, but are not limited to such a circular type. That is, the fixed substrate 110 and the mobile substrate 120 may be formed in various types, including a circular type and a Trombone type, under conditions in which they are formed in a microstrip line form.

Furthermore, the phase shifter may be configured to include a plurality of the fixed substrates 110 or a plurality of the mobile substrates 120. In some embodiments of the present invention, the phase shifter may be configured to include a plurality of the mobile substrates 120 (refer to FIG. 2) or a plurality of the fixed substrates 110. The reason for this is that the phases of multiple band signals or multiple polarization signals can be changed at the same time by forming the plurality of fixed substrates 110 or mobile substrates 120.

The conductive cover 200 is configured to shield the radiation of the fixed substrate 110 or the mobile substrate 120. More specifically, the conductive cover 200 functions to prevent the performance of an antenna from being deteriorated due to radio waves that are radiated by the fixed substrate 110 or mobile substrate 120 of a microstrip line form and drained outside the phase shifter. As described above, a high frequency band of 2 GHz or more may generate problems, such as a loss of a radio wave, the deterioration of an F/B characteristic, and an unstable PIM characteristic, due to the radiation of the microstrip line. In an embodiment of the present invention, such problems can be prevented using the conductive cover 200.

The conductive cover 200 may be configured to surround the fixed substrate 110 and the mobile substrate 120 disposed in such a way as to come in contact with each other. The conductive cover 200 may shield the fixed substrate 110 and the mobile substrate 120 in relations with other elements inside an antenna in addition to outside the antenna.

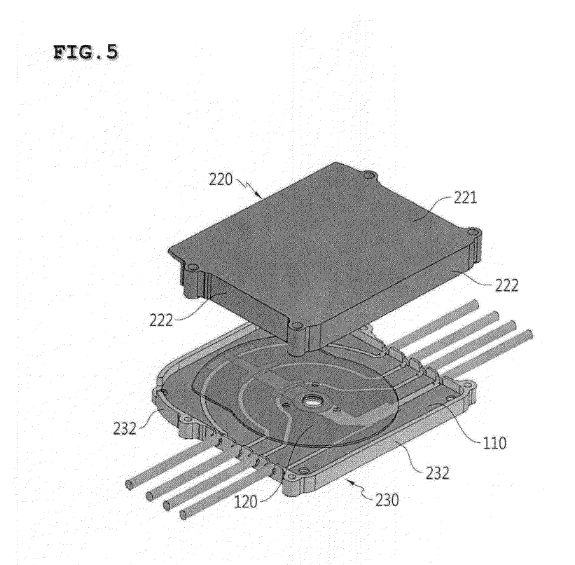

Furthermore, the conductive cover 200 may include a plurality of cover surfaces. Radiation waves radiated in a plurality of directions can be blocked using the plurality of cover surfaces. For example, as illustrated in FIG. 4, the conductive cover 200 may include a vertical cover surface 211 configured to shield radiation waves radiated in the normal direction of the fixed substrate 110 and the mobile substrate 120 and horizontal cover surfaces 212 configured to shield radiation waves radiated in the direction parallel to the fixed substrate 110 and the mobile substrate 120. In such a case, the conductive cover 200 may block radiation waves from being transferred to the radiation elements of an antenna, included in the normal direction of the substrates, using the vertical cover surface 211 and may also block radiation waves from being transferred to other elements within the antenna using the horizontal cover surfaces 212.

Furthermore, the conductive cover 200 may be formed of a metal cover or a die casting cover. The reason for this is that such metal or die casting materials may efficiently shield radiation waves.

In the phase shifter described above in accordance with an embodiment of the present invention, the substrates forming the phase shifter may be formed in a microstrip line form, and the substrates formed in a microstrip line form are shielded by the conductive cover 200. Accordingly, radiation waves generated by the microstrip lines are prevented from being transferred to the elements of an antenna or the outside of the antenna. Accordingly, the phase shifter can stably maintain an F/B characteristic and a PIM characteristic although the phase shifter operates in a high frequency band of 2 GHz or more.

Furthermore, the phase shifter described above in accordance with an embodiment of the present invention may be formed in the sector antenna of a mobile communication system. In the sector antenna field, there is an increasing need to implement an electrical beam tilt even in a high frequency band of 2 GHz or more according to the recent development of a mobile communication technology. The use of a microstrip phase shifter is greatly restricted due to reasons, such as a deteriorated F/B characteristic and an unstable PIM characteristic.

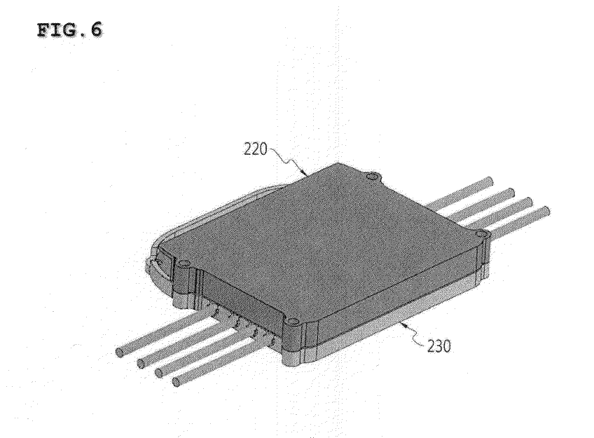

Hereinafter, a phase shifter in accordance with another embodiment of the present invention is described with reference to FIGS. 5 and 6.

Referring to FIGS. 5 and 6, the phase shifter in accordance with another embodiment of the present invention is the same as that of the aforementioned embodiment in that it includes the fixed substrate 110 and the mobile substrate 120 for dynamically forming a phase shift line, but differs from that of the aforementioned embodiment in that the conductive cover 200 is formed in a dual cover form.

More specifically, the conductive cover 200 has a dual structure including a first cover 220 and a second cover 230 in order to fully shield the fixed substrate 110 and the mobile substrate 120 that come in contact with each other.

In this case, in the state in which one surface (i.e., a surface in which the first line patterns 111 are formed) of the fixed substrate 110 and one surface (i.e., a surface in which the second line pattern 121 is formed) of the mobile substrate 120 have come in contact with each other with the insulating layer interposed therebetween, the first cover 220 is configured to shield radiation waves radiated in a lateral direction on the other surface of the mobile substrate 120 (i.e., a lateral direction on one surface of the fixed substrate 110). The first cover 220 may include a (1-1)^{th} cover 221 configured to shield radiation waves laterally radiated in the normal direction of the substrates and (1-2)^{th} covers 222 configured to shield radiation waves radiated in the direction parallel to the substrates.

Furthermore, the second cover 230 is configured to shield radiation waves radiated in a lateral direction on the other surface (i.e., a lateral direction on one surface of the mobile substrate 120) of the fixed substrate 110 in the state in which one surface of the fixed substrate 110 and one surface of the mobile substrate 120 have come in contact with each other with the insulating layer interposed therebetween. The second cover 230 may also include (2-1)^{th} cover (not illustrated) configured to shield radiation waves laterally radiated in the normal direction of the substrates and a (2-2)^{th} cover configured to shield radiation wave radiated in the direction parallel to the substrates.

The phase shifter in accordance with another embodiment of the present invention may fully shield the radiation of the substrates configured in a microstrip line form using the dual cover structure, thereby being capable of further improving an F/B characteristic and a PIM characteristic.

Hereinafter, an antenna in accordance with an embodiment of the present invention is described.

The antenna in accordance with an embodiment of the present invention may include a plurality of antenna radiation elements configured to radiate a radio wave of a high frequency band of 2 GHz or more, the phase shifter configured to guide an electrical beam tile of the antenna by shifting the phases of signals supplied to the plurality antenna radiation elements, and an antenna cover configured to protect the antenna radiation elements and the phase shifter against the outside.

The plurality of antenna radiation elements is configured to radiate a radio wave of a high frequency band of 2 GHz or more and may be disposed in a line. Signals having different phases from the phase shifter are supplied to the plurality of antenna radiation elements. Accordingly, the antenna radiation elements radiate radio waves having different phases, and an electrical beam tilt is implemented from a viewpoint of the entire antenna.

The phase shifter is configured to shift the phases of signals supplied to the plurality of antenna radiation elements.

The phase shifter may be formed in a microstrip line form as described above and is configured to include the fixed substrate 110 and the mobile substrate 120. In particular, the phase shifter may further include the conductive cover 200 for shielding the radiation of the microstrip lines. Accordingly, the F/B characteristic and PIM characteristic of the antenna can be stably maintained by the conductive cover 200 although the plurality of antenna radiation elements operates in a high frequency band of 2 GHz or more. The phase shifter and the elements thereof have been described in detail above, and descriptions thereof are omitted in order to avoid redundancy.

The antenna cover is configured to protect the elements of the antenna, including the plurality of antenna radiation elements and the phase shifter, against the outside.

The phase shifter may have a dual protection structure through such an antenna cover. More specifically, the substrates forming the phase shifter can be primarily protected by the conductive cover 200 and secondarily protected by the antenna cover.

Accordingly, the antenna in accordance with an embodiment of the present invention can solve problems, such as a deteriorated F/B characteristic and an unstable PIM characteristic that may be generated by the phase shifter of a microstrip line form in a high frequency band, and can also strongly protect the substrates of a microstrip line form that may be greatly damaged using the dual structure.

The antenna described above in accordance with an embodiment of the present invention may be formed in various types, but may be the sector antenna of a mobile communication system. The reason for this is that as described above, in the sector antenna field, there is an increasing need to implement an electrical beam tilt even in a high frequency band of 2 GHz or more according to the recent development of a mobile communication technology, but the use of a microstrip phase shifter is greatly restricted due to the aforementioned problems.

An embodiment of the present invention can implement the phase shifter formed in a microstrip line form and configured to not deteriorate the characteristics of an antenna although the phase shifter operates in a high frequency band of 2 GHz or more. More specifically, an embodiment of the present invention can implement the phase shifter including the conductive cover for shielding the radiation of the microstrip lines and thus can stably maintain the F/B characteristic and PIMD characteristic of an antenna although the phase shifter of a microstrip line form operates in a high frequency band of 2 GHz or more.

Advantages of the present invention are not limited to the aforementioned advantages and may include various other advantages that are evident to those skilled in the art to which the present invention pertains from the following description.

Furthermore, the antenna described above in accordance with an embodiment of the present invention may include substantially the same technical characteristics as the phase shifter according to an embodiment of the present invention although the antenna and the phase shifter belong to different categories. Accordingly, although a detailed description is not given in order to avoid redundancy, contents described in connection with the phase shifter may be naturally analogized and applied to the antenna.

The aforementioned embodiments of the present invention have been disclosed for illustrative purposes, and the present invention is not restricted by the embodiments. Furthermore, those skilled in the art to which the present invention pertains may modify and change the present invention in various ways within the spirit and scope of the present invention, and such modifications and changes should be construed as belonging to the scope of the present invention.

What is claimed is:

1. A phase shifter for shifting a phase of a signal, comprising:
a conductive cover formed in a microstrip line form and configured to shield a radiation of microstrip lines,
wherein the phase shifter operates in a frequency band of 2 GHz or more.

2. The phase shifter of claim 1, wherein:
the phase shifter implements an electrical beam tilt of a mobile communication radio wave in the frequency band of 2 GHz or more, and
the phase shifter is formed in a mobile communication sector antenna.

3. The phase shifter of claim 1, wherein the conductive cover comprises a metal cover or a die casting cover.

4. The phase shifter of claim 1, further comprising:
a fixed substrate formed in a microstrip line form; and
a mobile substrate configured to dynamically form a phase shift line along with the fixed substrate and formed in a microstrip line form,
wherein the conductive cover shields a radiation of the fixed substrate or the mobile substrate.

5. The phase shifter of claim 4, wherein a first surface of the fixed substrate and a first surface of the mobile substrate are disposed to come in contact with each other with an insulating layer interposed between the fixed substrate and the mobile substrate.

6. The phase shifter of claim 5, wherein the conductive cover comprises:
a vertical cover surface configured to shield radiation waves radiated in a direction normal to the fixed substrate and the mobile substrate; and
horizontal cover surfaces configured to shield radiation waves radiated in a direction parallel to the fixed substrate and the mobile substrate.

7. The phase shifter of claim 5, wherein the conductive cover comprises:
a first cover configured to shield radiation waves laterally radiated on a second surface of the mobile substrate; and
a second cover configured to shield radiation waves laterally radiated on a second surface of the fixed substrate.

8. An antenna comprising:
a phase shifter configured in a microstrip line form; and
radiation elements supplied with phase-shifted signals from the phase shifter and configured to radiate electromagnetic waves in a frequency band of 2 GHz or more,
wherein a conductive cover configured to shield a radiation of the phase shifter is formed in the antenna.
